(19) United States
(12) Patent Application Publication
(10) Pub. No.: US 2018/0178585 A1
(43) Pub. Date: Jun. 28, 2018

(54) TIRE PLY JOINT CONFIGURATION

(71) Applicant: THE GOODYEAR TIRE & RUBBER COMPANY, Akron, OH (US)

(72) Inventors: Hongbing CHEN, Broadview Heights, OH (US); Nathan Andrew HUNT, Akron, OH (US); Duane Thomas DELANEY, North Canton, OH (US); Chad Everett KENDALL, Wadsworth, OH (US); Gary Robert BURG, Massillon, OH (US)

(21) Appl. No.: 15/902,576

(22) Filed: Feb. 22, 2018

Related U.S. Application Data
(62) Division of application No. 15/236,955, filed on Aug. 15, 2016.
(60) Provisional application No. 62/212,243, filed on Aug. 31, 2015.

(51) Int. Cl. B60C 9/04; B29D 30/30; B29D 30/42; B60C 9/20

(52) U.S. Cl. CPC B60C 9/04; B29D 30/305; B29D 30/42; B60C 9/20; B29D 2030/423; B29D 2030/3085; B29D 2030/428; B60C 2009/0408; B60C 2009/0425; B29D 30/3042

(57) ABSTRACT

A method of forming a layer of tire ply is disclosed. A first strip of ply is provided having a plurality of evenly spaced reinforcement cords, having a spacing S, and having a lateral end, wherein the last cord is spaced apart from strip end a distance X, wherein X is not equal to S. A second strip of ply is provided having a plurality of evenly spaced reinforcement cords, having a spacing S, and having a lateral end, wherein the last cord is spaced apart from strip end a distance Y, wherein Y is not equal to S. The lateral ends of the first and second strip are joined together in a lap joint. The first and second lateral ends are overlapped so that the spacing X preferrably does not overlap, but may partially overlap with the spacing Y.

### FIELD OF THE INVENTION

The invention relates to tire ply and method of manufacturing ply.

### BACKGROUND OF THE INVENTION

Tires are typically comprised of one or more layers of ply. The one or more plies are typically applied in a sheet form onto a tire building drum. The sheet of ply is wrapped about the drum, cut to the desired length and then assembled together. The cut ends of each sheet are spliced together. The ends of the ply are typically overlapped as a lap joint, as shown in FIG. 3. This stock is then rolled up and taken to the tire building drum. Once built into a finished tire, the ply in regions B causes a restriction in the ply due to the added strength and stiffness of the overlapped ply cords. Regions A and C typically have excessive spreading between the cords due to their proximity to the restriction in region B. The overlap of ply material can contribute to tire high speed nonuniformity and can also cause visible depressions in the sidewall. It is known in the art to join the ply ends via a butt splice, wherein there is no overlap of material. However, forming a butt splice joint generally requires additional capital equipment in order to form the butt splice. The butt splice is also not as strong or as reliable as the lap slice.

Thus an improved method and apparatus for forming a splice that does not require an additional investment in capital equipment is described.

### SUMMARY OF THE INVENTION

The invention provides a method of forming a layer of tire ply by providing a first strip of ply having a plurality of evenly spaced reinforcement cords with a spacing S, and having a lateral end, wherein there is a distance X between the end of the first strip of ply and a reinforcement cord nearest the lateral end, wherein X is not equal to S. Providing a second strip of ply having a plurality of evenly spaced reinforcement cords having a spacing S, wherein there is a distance Y between the end of the second strip of ply and a reinforcement cord nearest the lateral end, wherein Y is not equal to S. Joining the first and second lateral ends to form an overlapped portion, wherein only a single cord of the first strip overlaps with a single cord of the second strip.

### DEFINITIONS

“Aspect Ratio” means the ratio of a tire's section height to its section width.

“Axial” and “axially” means the lines or directions that are parallel to the longitudinal axis of the ply. In reference to the tire, “axial” means lines or direction parallel to the rotational axis of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the radial direction, or lines or directions perpendicular to the radial direction;

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel reinforcement cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Lateral” means the outer end of the strip in the direction of the longitudinal axis of the strip.

### BRIEF DESCRIPTION OF THE DRAWINGS

The invention will be described by way of example and with reference to the accompanying drawings in which:

FIG. 1 is a schematic top view of a ply fabric undergoing shearing;

FIG. 2 is a schematic of the cut ply material shown spliced together on a tire drum;

FIG. 3 is a cross-sectional view of a conventional lap splice;

FIG. 4 is a cross-sectional view of a first embodiment of a lap joint formed from two ends of a ply which are joined together;

FIG. 5 is a cross-sectional view of a second embodiment of a lap joint formed from two ends of a ply which are joined together;

FIG. 6 is a cross-sectional view of a third embodiment of a lap joint formed from two ends of a ply which are joined together; and

FIG. 7 is a cross-sectional view of a portion of a tire in the bead area.

### DETAILED DESCRIPTION OF THE INVENTION

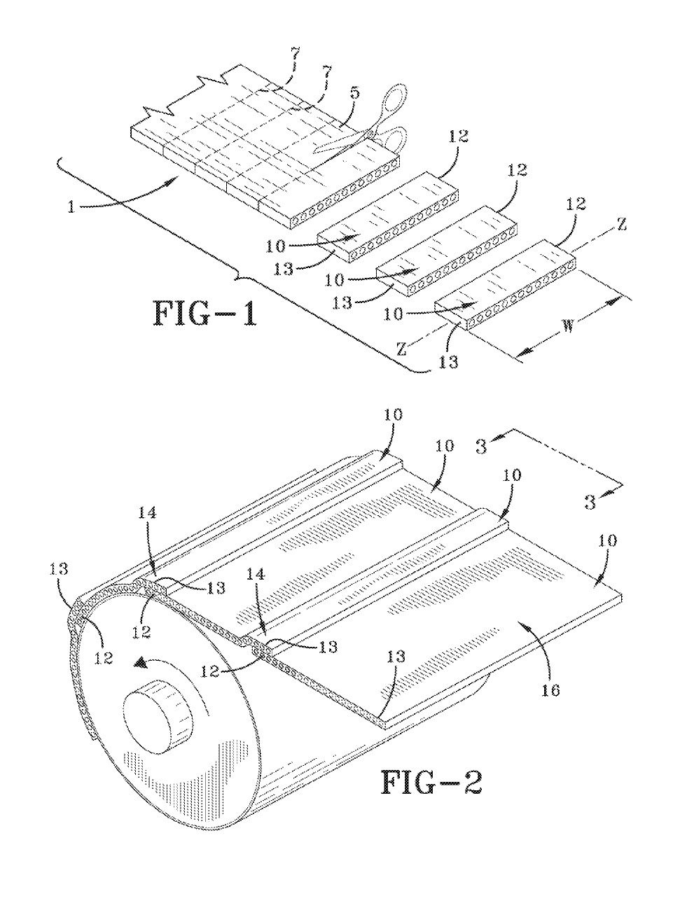

A first embodiment of the present invention is shown in FIG. 4, which illustrates a lap joint 30. The inventive lap joints described herein are useful for joining together ends of reinforcement ply. As shown in FIG. 4, the lap joint is also useful for joining together end 21 of first ply strip 20 end 23 of a second ply strip 24. Each ply strip 20,24 is the same as strip 10 shown in FIG. 1 except as described below. The ply strips have a defined width W and a defined length L, wherein W and L are sized as required. Typically the length L is greater than the width W. The reinforcement cords in each strip are in parallel alignment along the length of the strip with the longitudinal axis of the strip as shown in FIG. 2. The first ply strips 20,24 are made from the process as shown in FIG. 1, wherein the lateral end 13 of a first strip is joined to the lateral end 12 of a second strip in the form of a lap joint 14, continuing the process to form a sheet of ply 16 as shown in FIG. 2. The lateral ends 12,13 are overlapped and joined together, so that the cords of each end are in parallel alignment as shown in FIG. 2. The lap joint 14 may also be used to join together the lateral ends of a sheet of ply.

As shown in FIG. 4, the lateral end 21 of the first ply strip 20 has a plurality of parallel cords 22 arranged along the length of the strip of the material. The cords 22 are in parallel alignment and are evenly spaced apart a distance S throughout the length of the first ply 20, except at the lateral end 21. The ply cords typically have an epi (ends per inch) in the range of 17-35, resulting in a range of S of about 0.001 to about 0.02 inch. At the lateral edge, the spacing X as shown between the outer edge 29 of the last cord 28 and the end 21 of the ply strip 20 is 3.5S+3D, wherein S is the cord spacing, and D is the cord diameter. However, X may be from 1.5S+D, 2.5S+2D, 3.5S+3D, or 4.5S+4D.

The second ply strip 24 has a plurality of parallel aligned cords 25 arranged transverse to the length of the sheet of the material. The cords 25 are evenly spaced apart a distance C through the length of the second ply, except at the lateral end 23. At the lateral end 23, the spacing Y between the edge of the last cord and the lateral end 23 is a distance Y. Y may be 0.5C, 1.5C+D, to 2.5C+2D, 3.5C+3D, or 4.5S+4D, wherein D is the cord diameter and C is the cord spacing. As shown in FIG. 4, the spacing X is not in parallel alignment with the spacing Y, and the spacing X does not overlap with the spacing Y. As shown in FIG. 4, only a single cord 28 of the first ply strip 20 overlaps in the Z direction and is in parallel alignment with a single cord 39 of ply strip 24. In the spacing X and Y, there is no cord present, and there is no partial cord or broken cord present. It is preferred that X is not equal to Y, and that X is greater than Y. It is preferred that cord spacing C of the second ply strip equals cord spacing S of the first ply strip. It is preferred that strip 20 with spacing X is in full contact with inner liner on drum

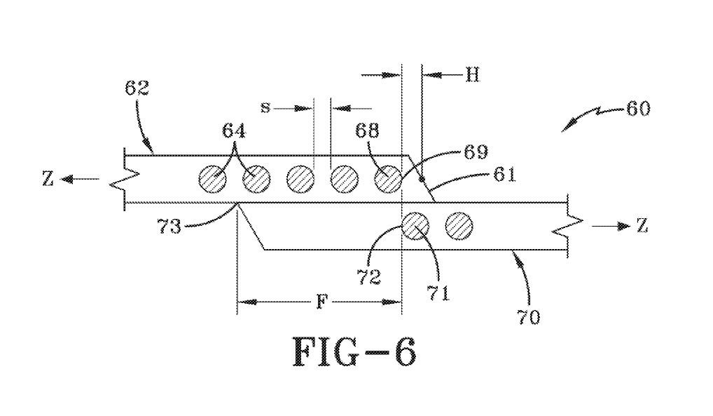

FIG. 5 illustrates a second embodiment 40 of a ply lap joint. The first ply strip 20 is the same as FIG. 4. The second ply strip 50 is different than the ply strip 24 of FIG. 4 as follows. The last cord 51 is spaced an interval G from the strip end 53. As shown in FIG. 5, the spacing X partially overlaps with the spacing G in the Z direction. Preferably the distance in the Z direction between cord edge 29 of cord 28 and cord edge 54 of cord 51 is in the range of 0.5S to S. As shown in FIG. 5, none of the cords of the first ply strip 20 overlap in the Z direction with cords 25 of the second ply strip 50. In the spacing X and G, there is no cord present, and there is no partial cord or broken cord present. It is preferred that X is not equal to G, and that X is greater than G. It is preferred that cord spacing C of the second ply strip equals cord spacing S of the first ply strip. It is preferred that strip 20 with spacing X is in full contact with inner liner on drum.

At the lateral edge of strip 20, the spacing X as shown between the outer edge 29 of the last cord 28 and the end 21 of the ply strip 20 is 3.5S+3D, wherein S is the cord spacing, and D is the cord diameter. However, X may be 1.5S+D, 2.5S+2D, 3.5S+3D, or 4.5S+4D. At the lateral edge of the second strip 50, the spacing G as shown between the outer edge 54 of the last cord 51 and the end 53 of the ply strip 50 is 2.5C+2D, wherein C is the cord spacing, and D is the cord diameter. However, G may also be 1.5S+D, 2.5S+2D, or 3.5S+3D. In the embodiment shown, due to the location of the X and G spacing, there is no double layer of cords in the lap joint.

FIG. 6 illustrates a third embodiment 60 with a slight overlap of the H and F spacing in the transverse direction. None of the cords in the first strip 62 overlap with the cords in the second strip 70 in the Z direction so that there is no double layer of cords in the lap joint. At the lateral edge of strip 62, the spacing H as shown between the outer edge 69 of the last cord 68 and the end 61 of the ply strip 62 is 0.5S, wherein S is the cord spacing. However, H may range from 0.25S to S. At the lateral edge of the second strip 70, the spacing F as shown between the outer edge 72 of the last cord 71 and the outermost end 73 of the ply strip 70 is 3.5C+4D, wherein C is the cord spacing, and D is the cord diameter. In the embodiment shown, due to the location of the H and F spacing, there is no overlap of cords in the Z direction, and thus no double layer of cords in the lap joint. It is preferred that the strip ends 61,73 are angled as shown. It is preferred that strip 70 is in full contact with drum.

The resulting lap joints described above have the strength of the prior art lap joint but without the disadvantage of the overlap of two functional cords.

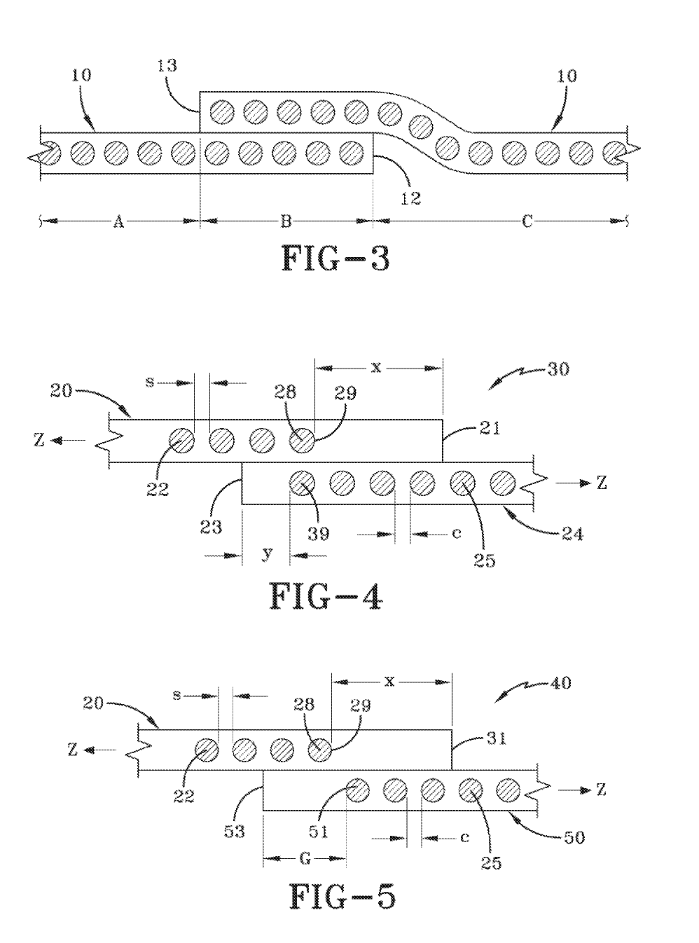

All of the lap joints described above overlap a distance B as shown in FIG. 3. The distance B is typically 1-6 mm.

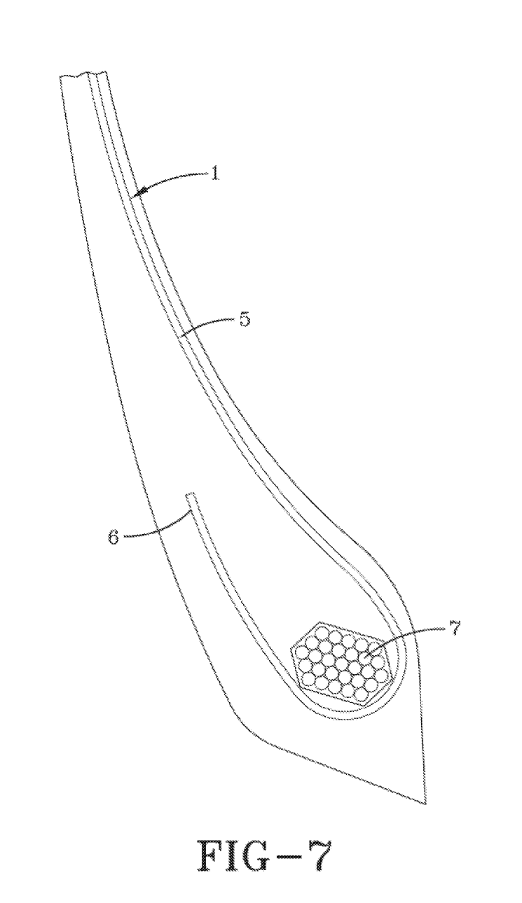

FIG. 7 illustrates a tire that has a layer of ply 5 wrapped around a bead 7. The ply is formed from a plurality of ply strips lap spliced together as shown in FIGS. 1-2 formed with a lap joints of any of the inventions described herein. The reinforcement cords are oriented in the radial direction of the tire. When the lap joint of FIGS. 4 through 7 are used, the overlap splice of the reinforcement cords align with the circumferential direction, transverse to the radial direction. The spacing X, Y, F,G, H, M likewise align in the transverse (circumferential) direction, perpendicular to the radial direction.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of forming a layer of tire ply comprising the following steps:
a. providing a first strip of ply having a plurality of evenly spaced reinforcement cords with a spacing S, and having a lateral end, wherein there is a distance X between the end of the first strip of ply and a reinforcement cord nearest the lateral end, wherein X is not equal to S;
b. providing a second strip of ply having a plurality of evenly spaced reinforcement cords having a spacing S, wherein there is a distance Y between the end of the second strip of ply and a reinforcement cord nearest the lateral end, wherein Y is not equal to S; and
c. joining the first and second lateral ends to form an overlapped portion, wherein only a single cord of the first strip overlaps with a single cord of the second strip.

2. The method of claim 1 wherein the spacing X does not overlap with the spacing Y.

3. The method of claim 1 wherein the spacing X is greater than the spacing Y.

4. The method of claim 1 wherein there are no cords a distance X from the lateral end of the first strip to the nearest reinforcement cord.

5. The method of claim 1 wherein there are no cords a distance Y from the lateral end of the second strip to the nearest reinforcement cord.

6. The method of claim 1 wherein X is 3.5S+3D, wherein S is the cord spacing of the first ply.

7. The method of claim 1 wherein Y is 1.5S+D.

8. The method of claim 1 wherein the X region of the lap joint has a single layer of cords.

9. The method of claim 1 wherein the Y region of the lap joint has a single layer of cords.

10. The method of claim 1 wherein only a single cord of the first strip lateral end is in parallel alignment with a single cord of the second strip lateral end.

11. A method of forming a layer of tire ply comprising the following steps:
a. providing a first strip of ply having a plurality of evenly spaced reinforcement cords with a spacing S, and having a lateral end, wherein there is a distance X between the end of the first strip of ply and a reinforcement cord nearest the lateral end, wherein X is not equal to S;
b. providing a second strip of ply having a plurality of evenly spaced reinforcement cords having a spacing S, wherein there is a distance Y between the end of the second strip of ply and a reinforcement cord nearest the lateral end, wherein Y is not equal to S; and
c. joining the first and second lateral ends to form an overlapped portion forming a single layer of cords.

12. The method of claim 11 wherein in the overlapped portion of the lap joint so there are no cords of the first lateral end that overlap with cords of the second lateral end.

13. The method of claim 11 wherein the cords of the first strip lateral end are not in alignment with the cords of the second strip lateral end.

14. The method of claim 11 wherein the spacing X does not overlap with the spacing Y.

15. The method of claim 11 wherein the spacing X is greater than the spacing Y.

16. The method of claim 11 wherein there are no cords or broken cords a distance X from the lateral end of the first strip to the nearest reinforcement cord.

17. The method of claim 11 wherein there are no cords or broken cords a distance Y from the lateral end of the second strip to the nearest reinforcement cord.

18. The method of claim 11 wherein X is 3.5S+3D, wherein S is the cord spacing of the first ply.

19. The method of claim 11 wherein Y is 2.5S+2D.

20. The method of claim 11 wherein a X region of the lap joint has a single layer of cords, wherein the X region is defined by the X distance of the first layer and the X distance of the second layer.

21-32. (canceled)
